(19) United States
(12) Patent Application Publication
(10) Pub. No.: US 2023/0288769 A1
(43) Pub. Date: Sep. 14, 2023

(54) SOLID POLYMER ELECTROLYTE MEMBRANE AND ELECTROCHROMIC DEVICE INCLUDING THE SAME

(71) Applicant: Ming Chi University of Technology, Taipei City (TW)

(72) Inventors: Wen-Liang HUANG, New Taipei City (TW); Chun-Chen YANG, New Taipei City (TW)

(73) Assignee: Ming Chi University of Technology, Taipei City (TW)

(21) Appl. No.: 17/953,551

(22) Filed: Sep. 27, 2022

(30) Foreign Application Priority Data
Mar. 8, 2022 (TW) 111108385

(51) Int. Cl. G02F 1/1523; G02F 1/155

(52) U.S. Cl. CPC G02F 1/1525; G02F 1/155; G02F 2001/164

(57) ABSTRACT

Disclosed herein is a solid polymer electrolyte membrane prepared by subjecting an oligomer-containing composition to a polymerization reaction. The oligomer-containing composition includes ethoxylated multifunctional acrylate monomer, polyether amine oligomer, and a lithium salt. An electrochromic device including an anode, a cathode, and the solid polymer electrolyte membrane is also disclosed. The solid polymer electrolyte membrane is disposed between the anode and the cathode.

### CROSS-REFERENCE TO RELATED APPLICATION

This application claims priority of Taiwanese Invention Patent Application No. 111108385, filed on Mar. 8, 2022.

### FIELD

The present disclosure relates to a solid polymer electrolyte membrane. The present disclosure also relates to an electrochromic device including the solid polymer electrolyte membrane.

### BACKGROUND

A light transmittance of an electrochromic device can be significantly changed under a visible light spectrum by applying voltage, thereby affecting coloring or bleaching of the electrochromic device. The electrochromic device might stably maintain the resulting color after the power supply is turned off. Such electrochromic device can be applied to energy-saving smart window, which generally includes metal oxides serving as the electrochromic material, and electrolytes that allow conductive ions (e.g., lithium ions) to move therein.

The aforesaid electrochromic device, if the electrolytes are in a liquid form, usually has good ion conductivity; however, there are risks of liquid leakage, and thermal expansion and contraction. On the other hand, such electrochromic device generally has a poor ion conductivity if the electrolytes are in a solid form (e.g., polymer electrolytes).

### SUMMARY

Therefore, an object of the present disclosure is to provide a solid polymer electrolyte membrane, and an electrochromic device.

According to one aspect of the present disclosure, the solid polymer electrolyte membrane is prepared by subjecting an oligomer-containing composition to a polymerization reaction. The oligomer-containing composition includes ethoxylated acrylate monomer, polyether amine oligomer, and a lithium salt.

According to another aspect of the present disclosure, the electrochromic device includes an anode, a cathode and the aforesaid solid polymer electrolyte membrane. The solid polymer electrolyte membrane is disposed between the anode and the cathode.

### BRIEF DESCRIPTION OF THE DRAWINGS

Other features and advantages of the disclosure will become apparent in the following detailed description of the embodiment(s) with reference to the accompanying drawing(s), of which:

FIG. 1 is a graph illustrating light transmittance rate over time of an electrochromic device of Example 2 according to the present disclosure after 4 cycles of exposure to visible light having a wavelength of 550 nm.

### DETAILED DESCRIPTION

It is to be understood that, if any prior art publication is referred to herein, such reference does not constitute an admission that the publication forms a part of the common general knowledge in the art, in Taiwan or any other country.

For the purpose of this specification, it will be clearly understood that the word “comprising” means “including but not limited to”, and that the word “comprises” has a corresponding meaning.

Unless defined otherwise, all technical and scientific terms used herein have the meaning commonly understood by a person skilled in the art to which the present disclosure belongs. One skilled in the art will recognize many methods and materials similar or equivalent to those described herein, which could be used in the practice of the present disclosure. Indeed, the present disclosure is in no way limited to the methods and materials described.

The present disclosure provides a solid polymer electrolyte membrane which is prepared by subjecting an oligomer-containing composition to a polymerization reaction. The oligomer-containing composition includes ethoxylated acrylate monomer, polyether amine oligomer, and a lithium salt.

In certain embodiments, the polyether amine oligomer has a weight average molecular weight ranging from 200 g/mol to 1000 g/mol.

In certain embodiments, the ethoxylated acrylate monomer is ethoxylated trimethylolpropane triacrylate.

In certain embodiments, a weight ratio of the ethoxylated acrylate monomer to the polyether amine oligomer in the oligomer-containing composition ranges from 6:1 to 40:1. In exemplary embodiments, the weight ratio of the ethoxylated acrylate monomer to the polyether amine oligomer in the oligomer-containing composition ranges from 34:5 to 39:1.

In certain embodiments, the oligomer-containing composition further includes zeolitic imidazolate framework. In an exemplary embodiment, the zeolitic imidazolate framework is cobalt 2-methylimidazole (ZIF-67).

In certain embodiments, the oligomer-containing composition further includes a plasticizer and a photoinitiator. In an exemplary embodiment, the plasticizer is succinonitrile, and the photoinitiator is pyromellitic dianhydride.

In certain embodiments, the lithium salt is selected from the group consisting of lithium bis(trifluoromethanesulfonyl)imide, lithium polystyrene sulfonate, lithium iodide, and combinations thereof.

The present disclosure also provides an electrochromic device which includes an anode, a cathode, and the aforesaid solid polymer electrolyte membrane. The solid polymer electrolyte membrane is disposed between the anode and the cathode.

In certain embodiments, the electrochromic device further includes an electrode-interface modification layer which is disposed on at least one of the anode and the cathode, and which is sandwiched between the solid polymer electrolyte membrane and the at least one of the anode and the cathode.

In certain embodiments, the electrode-interface modification layer is made from a composition including poly(vinyl alcohol), ethoxylated acrylate monomer, and a lithium salt.

In certain embodiments, the anode is made from an anode material including nickel(II) oxide (NiO).

In certain embodiments, the cathode is made from a cathode material including tungsten(VI) trioxide (WO₃).

The present disclosure will be further described by way of the following examples. However, it should be understood that the following examples are intended solely for the purpose of illustration and should not be construed as limiting the present disclosure in practice.

### EXAMPLES

### Preparation of Solid Polymer Electrolyte Membrane

### Example 1 (EX1)

Ethoxylated trimethylolpropane triacrylate (ETPTA, weight average molecular weight of 912 g/mol, commercially available from Sigma-Aldrich), Jeffamine® M-1000 (commercially available from Huntsman), lithium bis(trifluoromethanesulfonyl)imide (LiTFSI, commercially available from Sigma-Aldrich), and succinonitrile (SN, commercially available from Sigma-Aldrich), in a weight ratio of 39:1:30:30, were mixed under stirring in an argon atmosphere at room temperature (25° C.) for 8 hours, so as to form a mixture. After that, pyromellitic dianhydride (PMDA) was added to the mixture in an amount of 1 wt % based on a total weight (100 wt %) of ETPTA, and continuous stirring was conducted for 2 hours, so as to obtain an oligomer-containing composition that is solvent-free.

The oligomer-containing composition was coated on a substrate, and then subjected to irradiation with ultraviolet light having an intensity of 30 mW/cm² and a wavelength of 365 nm for about 10 minutes to 15 minutes, so as to obtain a solid polymer electrolyte membrane of EX1 that is transparent and free from solvent.

### Examples 2 and 3 (EX2 and EX3)

The procedures and conditions for preparing the solid polymer electrolyte membranes of EX2 and EX3 were similar to those of Example 1, except that, the weight ratios of ETPTA to Jeffamine® M-1000 in EX2 and EX3 were 38:2 and 37:3, respectively.

### Examples 4 and 5 (EX4 and EX5)

The procedures and conditions for preparing the solid polymer electrolyte membranes of EX4 and EX5 were similar to those of Example 1, except that, in EX4 and EX5, Jeffamine® M-1000 was replaced with Jeffamine® D-230 and Jeffamine® D-400, respectively.

### Example 6 (EX6)

The procedures and conditions for preparing the solid polymer electrolyte membrane of EX6 were similar to those of EX1, except that, in EX6, lithium polystyrene sulfonate (LiPSS) was additionally added to ETPTA, Jeffamine® M-1000, LiTFSI and SN before addition of PMDA, and the weight ratio of ETPTA to Jeffamine® M-1000 to LiPSS to LiTFSI and to SN was 37:2:1:30:30.

### Example 7 (EX7)

The procedures and conditions for preparing the solid polymer electrolyte membrane of EX7 were similar to those of EX4, except that, in EX7, lithium iodide (LiI) was additionally added to ETPTA, Jeffamine® M-1000, LiTFSI and SN before addition of PMDA, and the weight ratio of ETPTA to Jeffamine® D-230 to LiI to LiTFSI and to SN was 34:5:1:30:30.

### Example 8 (EX8)

The procedures and conditions for preparing the solid polymer electrolyte membrane of EX8 were similar to those of EX4, except that, in EX8, cobalt 2-methylimidazole (ZIF-67) was additionally added to ETPTA, Jeffamine® M-1000, LiTFSI and SN before addition of PMDA, and the weight ratio of ETPTA to Jeffamine® D-230 to ZIF-67 to LiTFSI and to SN was 34:5:1:30:30.

### Comparative Example 1 (CE1)

The procedures and conditions for preparing the solid polymer electrolyte membrane of CE1 were similar to those of EX1, except that, in CE1, Jeffamine® M-1000 was not added to form the mixture, and the weight ratio of ETPTA to Jeffamine® M-1000 to LiTFSI and to SN was 40:0:30:30.

### Comparative Example 2 (CE2)

The procedures and conditions for preparing the solid polymer electrolyte membrane of CE2 were similar to those of EX6, except that, in CE2, Jeffamine® M-1000 was not added to form the mixture, and the weight ratio of ETPTA to Jeffamine® M-1000 to LiPSS to LiTFSI to and SN was 39:0:1:30:30.

### Comparative Example 3 (CE3)

The procedures and conditions for preparing the solid polymer electrolyte membrane of CE3 were similar to those of EX1, except that Jeffamine® M-1000 was replaced with polyethylene glycol (PEG-400, commercially available from Sigma-Aldrich).

### Preparation of Negative Electrode (Anode)

A nickel(II) oxide (NiO) sol (containing 2.3 wt % NiO), Pluronic® F108, Pluronic® F127, Pluronic® P123, tetraethoxysilane (TEOS), vapor grown carbon fiber (VGCF, commercially available from Yonyu Applied Technology Material Co., Ltd., Model no.: GS013010) and LiTFSI, in a weight ratio of 87.4:1:8:1:1.5:0.1:1, were evenly mixed under stirring in ethanol, so as to obtain a negative electrode slurry (i.e., an anode material). The negative electrode slurry was subjected to ball milling using a ball miller (commercially available from Fritsch GmbH, Model: Planetary Micro Mill PULVERISETTE 7) at a rotation speed of 800 rpm with the agate ball having a diameter of about 2 mm, for 2 hours, and then coated on a surface of an indium tin oxide (ITO) conductive glass which had been surface-treated by atmospheric plasma and which had a contact resistivity of about 5 Ω·cm² to 8 Ω·cm², followed by baking at 300° C. for 30 minutes to remove ethanol, so as to obtain a negative electrode (anode) that was formed on the surface of the ITO conductive glass and that had a thickness ranging from about 200 nm to 500 nm.

### Preparation of Positive Electrode (Cathode)

A tungsten trioxide (WO₃) sol (containing 4 wt % WO₃), PEG-400 and VGCF, in a weight ratio of 98.9:1:0.1, were evenly mixed under stirring in ethanol so as to obtain a positive electrode slurry (i.e., cathode material). The positive electrode slurry was coated on a surface of an ITO conductive glass, which had been surface-treated by atmospheric plasma and which had a contact resistivity of about 5 Ω·cm² to 8 Ω·cm², and then subjected to baking at 260° C. for 30 minutes to remove ethanol, so as to obtain a positive electrode (cathode) that was formed on the surface of the ITO conductive glass and that has a thickness ranging from about 150 nm to 200 nm.

### Preparation of Electrode-Interface Modification Layer

Polyvinyl alcohol (PVA, weight average molecular weight of 89,000 g/mol to 98,000 g/mol, commercially available from Sigma-Aldrich), ETPTA (weight average molecular weight of 912 g/mol), LiTFSI, SN and dimethyl sulfoxide (DMSO), in a weight ratio of 7:1:2.8:2.8:86.4, were evenly mixed under stirring at 80° C. for 2 hours, so as to obtain an electrode-interface modification composition. The electrode-interface modification composition was applied, by dip coating, to the surfaces of the negative electrode (anode) and the positive electrode (cathode) sheet, respectively, followed by drying at 80° C., so as to obtain electrode-interface modification layers formed on the surfaces of the negative electrode (anode) and positive electrode (cathode), respectively.

### Preparation of Electrochromic Device

A respective one of the oligomer-containing compositions (solvent-free) of EX1 to EX8 and CE1 to CE3 was coated on the electrode-interface modification layer formed on the surface of the anode, and then the electrode-interface modification layer formed on the surface of the positive electrode (cathode) was directed toward the oligomer-containing composition coated on the negative electrode (anode) to be bonded thereto, followed by irradiation of the oligomer-containing composition with an ultraviolet light having an intensity of 30 mW/cm² and a wavelength of 365 nm for a time period of about 10 minutes to 15 minutes, so as to form the solid polymer electrolyte membrane, (i.e., a corresponding one of the solid polymer electrolyte membranes of EX1 to EX8 and CE1 to CE3).

The periphery of the respective one of the solid polymer electrolyte membranes of EX1 to EX8 and CE1 to CE3 was sealed with Surlyn® film (commercially available from DuPont), so as to obtain a corresponding one of the electrochromic devices of EX1 to EX8 and CE1 to CE3 (i.e., ECD_{E1} to ECD_{E8} and ECD_{CE1} to ECD_{CE3}).

### Property Evaluation

### 1. Electrical Test

The respective one of the solid polymer electrolyte membranes of EX1 to EX8 and CE1 to CE3 was fixedly positioned in an oven, having a constant temperature of 25° C., and then subjected to an AC impedance spectroscopy using a potentiostat (commercially available from Metrohm AG, Model: Autolab PGSTAT302N), in which scanning was conducted under a frequency ranging from 100000 Hz to 100 Hz and a constant amplitude of 5 mV, so as to determine lithium ion conductivity (σᵢ) using the following formula:

$${σ}_{i} = \frac{L}{{R}_{b} \times A}$$

where σᵢ=lithium ion conductivity (S/cm)
L=thickness (cm)
R_{b}=bulk resistance (Ω)
A=cross-sectional area (cm²)

The results are shown in Table 1 below.

TABLE 1

| Solid polymer | Bulk | Lithium ion |
|---|---|---|
| electrolyte | resistance, | conductivity |
| membrane | R_{b} (Ω) | (S/cm) at 25° C. |
| EX1 | 10.25 | 1.52 × 10⁻⁴ |
| EX2 | 11.85 | 1.72 × 10⁻⁴ |
| EX3 | 12.50 | 1.46 × 10⁻⁴ |
| EX4 | 8.04 | 2.25 × 10⁻⁴ |
| EX5 | 14.71 | 1.28 × 10⁻⁴ |
| EX6 | 11.09 | 1.51 × 10⁻⁴ |
| EX7 | 5.00 | 5.29 × 10⁻⁴ |
| EX8 | 4.45 | 2.15 × 10⁻⁴ |
| CE1 | 32.14 | 7.10 × 10⁻⁵ |
| CE2 | 25.09 | 7.06 × 10⁻⁵ |
| CE3 | 38.99 | 4.80 × 10⁻⁵ |

As shown in Table 1, the bulk resistance (R_{b}) of the solid polymer electrolyte membranes of EX1 to EX8 was less than 15Ω, i.e., significantly lower than the bulk resistance of the solid polymer electrolyte membranes of CE1 to CE3 (greater than 25Ω). In addition, the lithium ion conductivity of the solid polymer electrolyte membranes of EX1 to EX8 was greater than 1.2×10⁻⁴ S/cm, i.e., significantly greater than the lithium ion conductivity of the solid polymer electrolyte membranes of CE1 to CE3 (less than 7.1×10⁻⁵ S/cm), demonstrating that the solid polymer electrolyte membranes of EX1 to EX8 have an improved lithium ion conductivity.

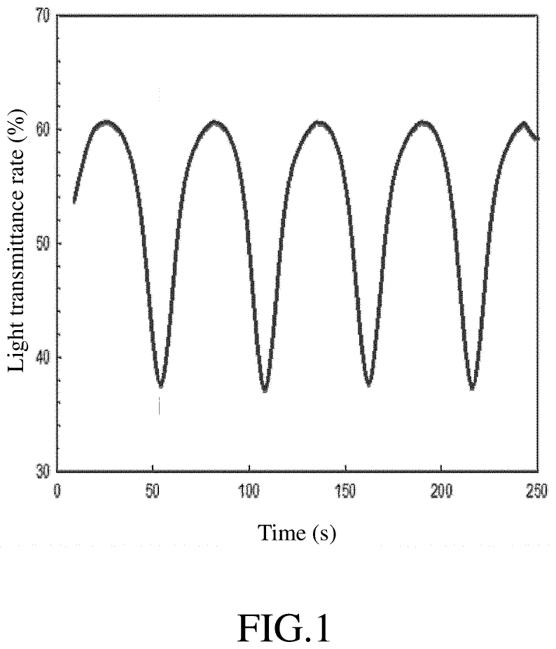

The electrochromic device of EX2 (i.e., ECD_{E2}) including the solid polymer electrolyte membrane of EX2 was subjected to determination of light transmittance rate over time which was conducted by subjecting the ECD_{E2} to 4 cycles of exposure to a visible light having a wavelength of 550 nm at a temperature of 25° C. (each cycle of exposure includes applying voltage of −2 V and current of 0.3 μA for seconds, and voltage of 2 V and current of 0.3 μA for 30 seconds). The results are shown in FIG. 1.

As shown in FIG. 1, difference in the light transmittance rate over time of ECD_{E2} was greater than 20% for each cycle, indicating that ECD_{E2} exhibits a huge color change and a good cycling stability at 25° C.

In summary, the solid polymer electrolyte membrane of the present disclosure has a good lithium ionic conductivity, and the electrochromic device including the solid polymer electrolyte membrane of the present disclosure exhibits a huge color change and a good cycling stability.

In the description above, for the purposes of explanation, numerous specific details have been set forth in order to provide a thorough understanding of the embodiments. It will be apparent, however, to one skilled in the art, that one or more other embodiments may be practiced without some of these specific details. It should also be appreciated that reference throughout this specification to “one embodiment,” “an embodiment,” an embodiment with an indication of an ordinal number and so forth means that a particular feature, structure, or characteristic may be included in the practice of the disclosure. It should be further appreciated that in the description, various features are sometimes grouped together in a single embodiment, figure, or description thereof for the purpose of streamlining the disclosure and aiding in the understanding of various inventive aspects, and that one or more features or specific details from one embodiment may be practiced together with one or more features or specific details from another embodiment, where appropriate, in the practice of the disclosure.

While the disclosure has been described in connection with what is considered the exemplary embodiment, it is understood that this disclosure is not limited to the disclosed embodiment but is intended to cover various arrangements included within the spirit and scope of the broadest interpretation so as to encompass all such modifications and equivalent arrangements.

What is claimed is:

1. A solid polymer electrolyte membrane, which is prepared by subjecting an oligomer-containing composition to a polymerization reaction,
wherein said oligomer-containing composition includes ethoxylated acrylate monomer, polyether amine oligomer, and a lithium salt.

2. The solid polymer electrolyte membrane as claimed in claim 1, wherein said polyether amine oligomer has a weight average molecular weight ranging from 200 g/mol to 1000 g/mol.

3. The solid polymer electrolyte membrane as claimed in claim 1, wherein said ethoxylated acrylate monomer is ethoxylated trimethylolpropane triacrylate.

4. The solid polymer electrolyte membrane as claimed in claim 1, wherein a weight ratio of said ethoxylated acrylate monomer to said polyether amine oligomer in said oligomer-containing composition ranges from 6:1 to 40:1.

5. The solid polymer electrolyte membrane as claimed in claim 1, wherein said oligomer-containing composition further includes zeolitic imidazolate framework.

6. The solid polymer electrolyte membrane as claimed in claim 1, wherein said oligomer-containing composition further includes a plasticizer and a photoinitiator.

7. The solid polymer electrolyte membrane as claimed in claim 1, wherein said lithium salt is selected from the group consisting of lithium bis(trifluoromethanesulfonyl)imide, lithium polystyrene sulfonate, lithium iodide, and combinations thereof.

8. An electrochromic device, comprising an anode, a cathode, and a solid polymer electrolyte membrane as claimed in claim 1,
wherein said solid polymer electrolyte membrane is disposed between said anode and said cathode.

9. The electrochromic device as claimed in claim 8, further comprising, an electrode-interface modification layer which is disposed on at least one of said anode and said cathode, and which is sandwiched between said solid polymer electrolyte membrane and said at least one of said anode and said cathode.

10. The electrochromic device as claimed in claim 9, wherein said electrode-interface modification layer is made from a composition including poly(vinyl alcohol), ethoxylated acrylate monomer, and a lithium salt.

11. The electrochromic device as claimed in claim 8, wherein said anode is made from an anode material including nickel(II) oxide.

12. The electrochromic device as claimed in claim 8, wherein said cathode is made from a cathode material including tungsten(VI) trioxide.
